(19) United States
(12) Patent Application Publication
(10) Pub. No.: US 2019/0066202 A1
(43) Pub. Date: Feb. 28, 2019

(54) Method, System, and Computer Program Product for Issuer Settlement Account Management

(71) Applicant: Visa International Service Association, San Francisco, CA (US)

(72) Inventors: Karen L. Cervenka, Belmont, CA (US); David Tseselsky, San Jose, CA (US); Brendan Xavier Louis, Manteca, CA (US); Sushma Bhoja Shetty, Reston, VA (US)

(21) Appl. No.: 16/108,775

(22) Filed: Aug. 22, 2018

Related U.S. Application Data
(60) Provisional application No. 62/549,982, filed on Aug. 25, 2017.

(51) Int. Cl. G06Q 40/02; G06Q 20/40; G06Q 20/10

(52) U.S. Cl. CPC G06Q 40/02; G06Q 20/10; G06Q 20/4016

(57) ABSTRACT

Described are a system, method, and computer program product for dynamically monitoring and managing at least one financial settlement account of at least one issuer institution. The method includes determining a minimum deposit requirement of a predesignated account, generating at least one transaction limit threshold for the at least one issuer institution, and receiving transaction data representative of a plurality of financial transactions between at least one merchant and at least one transaction device holder. The method also includes determining an aggregate transaction volume of the at least one issuer institution and comparing the aggregate transaction volume to the at least one transaction limit threshold. The method further includes, in response to the aggregate transaction volume equaling or exceeding the at least one transaction limit threshold, triggering at least one risk-mitigation action.

### CROSS REFERENCE TO RELATED APPLICATION

This application claims the benefit of U.S. Provisional Patent Application No. 62/549,982, filed Aug. 25, 2017, the entire content of which is hereby incorporated by reference.

### BACKGROUND OF THE INVENTION

### 1. Field of the Invention

Disclosed embodiments relate generally to a system, method, and computer program product for dynamically monitoring and managing one or more financial settlement accounts of one or more issuer institutions, and in non-limiting embodiments or aspects, to a system, method, and computer program product for monitoring aggregate transaction activity with dynamically controlled transaction thresholds and automatically triggered risk-mitigation actions.

### 2. Technical Considerations

Managing risk is a central concern for transaction service providers who facilitate financial transactions (e.g., credit transactions, debit transactions, etc.) with issuer institutions. Issuer institutions are often given credit limits, and financial settlement risk personnel associated with the transaction service provider may manually set credit limit thresholds for each issuer institution. If the credit transaction volume of an issuer institution passes a credit limit threshold, it is up to the financial settlement risk personnel to take action to mitigate the growing risk of non-payment or incomplete payment. Such actions may include contacting issuer institutions to ensure payment or initiating transaction controls, such as declining incoming credit transactions.

Constant personnel supervision and intervention is time-consuming and costly to the transaction service provider. There is a need in the art to automatically monitor financial transaction volume in comparison to one or more financial transaction thresholds. There is further a need in the art to automatically take action when thresholds are exceeded to mitigate the risk of non-payment/incomplete payment. Moreover, there is a need to dynamically adjust transaction thresholds when issuer institutions engage in requested risk-mitigating behavior.

### SUMMARY OF THE INVENTION

Accordingly, and generally, provided is an improved system, computer-implemented method, and computer program product for dynamically monitoring and managing a financial settlement account of an issuer institution.

According to some non-limiting embodiments or aspects, provided is a computer-implemented method for dynamically monitoring and managing at least one financial settlement account of at least one issuer institution. The method includes determining, with at least one processor and based at least partially on historic transaction data, a minimum deposit requirement of a predesignated account associated with the at least one issuer institution. The method also includes generating, with at least one processor and based at least partially on a balance of the predesignated account, at least one transaction limit threshold for the at least one issuer institution. The method further includes receiving, with at least one processor, transaction data representative of a plurality of financial transactions between at least one merchant and at least one transaction device holder associated with the at least one issuer institution completed over a first time period. The transaction data includes at least transaction amounts of the plurality of financial transactions. The method further includes determining, with at least one processor and based at least partially on the transaction data, an aggregate transaction volume of the at least one issuer institution. The method further includes comparing, with at least one processor, the aggregate transaction volume to the at least one transaction limit threshold. The method further includes, in response to the aggregate transaction volume equaling or exceeding the at least one transaction limit threshold, triggering at least one risk-mitigation action with at least one processor. The at least one risk-mitigation action includes at least one of the following: automatically transmitting a communication to the at least one issuer institution requesting additional funds to be deposited in the predesignated account; automatically transmitting a communication to the at least one issuer institution warning of other impending or recently implemented risk-mitigation actions; throttling incoming financial transactions from the at least one issuer institution by declining at least one incoming transaction based on at least one predetermined transaction parameter; declining all incoming financial transactions from the at least one issuer institution; or any combination thereof.

In further non-limiting embodiments or aspects, the at least one transaction limit threshold may include a first threshold amount and a second threshold amount greater than or equal to the first threshold amount. The triggering of the at least one risk-mitigation action may include, in response to the aggregate transaction volume meeting or exceeding the first threshold amount, automatically transmitting, with at least one processor, a communication to the at least one issuer institution requesting additional funds to be deposited in the predesignated account. The triggering of the at least one risk-mitigation action may also include, in response to the aggregate transaction volume meeting or exceeding the second threshold amount, throttling, with at least one processor, incoming financial transactions from the at least one issuer institution by declining at least one incoming transaction based on at least one predetermined transaction parameter.

In further non-limiting embodiments or aspects, the at least one transaction limit threshold may include a third threshold amount greater than or equal to the first threshold amount and the second threshold amount. The triggering of the at least one risk-mitigation action may include, in response to the aggregate transaction volume meeting or exceeding the third threshold amount, declining, with at least one processor, all incoming financial transactions from the at least one issuer institution.

In further non-limiting embodiments or aspects, the method may include automatically generating, with at least one processor, a communication to the at least one issuer institution including a request for the at least one issuer institution to deposit funds in the predesignated account, the funds to be deposited equal to or exceeding the minimum deposit requirement. The method may also include, in response to verifying that the balance of the predesignated account equals or exceeds the minimum deposit requirement, transmitting, with at least one processor, a communication to the at least one issuer institution confirming receipt of the funds to be deposited.

In further non-limiting embodiments or aspects, the method may include, in response to verifying receipt of new deposited funds in the predesignated account, generating, with at least one processor and based at least partially on the balance of the predesignated account, at least one new transaction limit threshold for the at least one issuer institution. The method may also include receiving, with at least one processor, new transaction data. The method may further include determining, with at least one processor and based at least partially on the new transaction data, the aggregate transaction volume. The method may further include comparing, with at least one processor, the aggregate transaction volume to the at least one new transaction limit threshold. The method may further include generating, with at least one processor, a new communication to the at least one issuer institution including a request for the at least one issuer institution to deposit additional funds in the predesignated account. The method may further include verifying, with at least one processor, a new receipt of funds into the predesignated account from the at least one issuer institution. The method may further include modifying, with at least one processor and based at least partially on the balance of the predesignated account, the at least one new transaction limit threshold for the predesignated account of the at least one issuer institution.

In further non-limiting embodiments or aspects, the at least one risk-mitigation action may include throttling incoming financial transactions from the at least one issuer institution by declining at least one incoming transaction based on at least one predetermined transaction parameter. The at least one predetermined transaction parameter of a given financial transaction may include at least one of the following: a transaction type of the financial transaction including a restricted type; a transaction amount of the financial transaction exceeding a restricted amount; a transaction time of the financial transaction being within a restricted time span since a prior financial transaction; or any combination thereof.

According to some non-limiting embodiments or aspects, provided is a system for dynamically monitoring and managing at least one financial settlement account of at least one issuer institution. The system includes at least one server computer including at least one processor. The at least one server computer is programmed and/or configured to determine, based at least partially on historic transaction data, a minimum deposit requirement of a predesignated account associated with the at least one issuer institution. The at least one server computer is also programmed and/or configured to generate, based at least partially on a balance of the predesignated account, at least one transaction limit threshold for the at least one issuer institution. The at least one server computer is further programmed and/or configured to receive transaction data representative of a plurality of financial transactions between at least one merchant and at least one transaction device holder associated with the at least one issuer institution completed over a first time period. The transaction data includes at least transaction amounts of the plurality of financial transactions. The at least one server computer is further programmed and/or configured to determine, based at least partially on the transaction data, an aggregate transaction volume of the at least one issuer institution. The at least one server computer is further programmed and/or configured to compare the aggregate transaction volume to the at least one transaction limit threshold. The at least one server computer is further programmed and/or configured to, in response to the aggregate transaction volume equaling or exceeding the at least one transaction limit threshold, trigger at least one risk-mitigation action. The at least one risk-mitigation action includes at least one of the following: automatically transmitting a communication to the at least one issuer institution requesting additional funds to be deposited in the predesignated account; throttling incoming financial transactions from the at least one issuer institution by declining at least one incoming transaction based on at least one predetermined transaction parameter; declining all incoming financial transactions from the at least one issuer institution; or any combination thereof.

In further non-limiting embodiments or aspects, the at least one transaction limit threshold may include a first threshold amount and a second threshold amount greater than or equal to the first threshold amount. The triggering of the at least one risk-mitigation action may include, in response to the aggregate transaction volume meeting or exceeding the first threshold amount, automatically transmitting a communication to the at least one issuer institution requesting additional funds to be deposited in the predesignated account. The triggering of the at least one risk-mitigation action may also include, in response to the aggregate transaction volume meeting or exceeding the second threshold amount, throttling incoming financial transactions from the at least one issuer institution by declining at least one incoming transaction based on at least one predetermined transaction parameter. The at least one transaction limit threshold may also include a third threshold amount greater than or equal to the first threshold amount and the second threshold amount. The triggering of the at least one risk-mitigation action may further include, in response to the aggregate transaction volume meeting or exceeding the third threshold amount, declining all incoming financial transactions from the at least one issuer institution.

In further non-limiting embodiments or aspects, the at least one server computer may be programmed and/or configured to automatically generate a communication to the at least one issuer institution including a request for the at least one issuer institution to deposit funds in the predesignated account. The funds to be deposited may equal or exceed the minimum deposit requirement. The at least one server computer may also be programmed and/or configured to, in response to verifying that the balance of the predesignated account equals or exceeds the minimum deposit requirement, transmit a communication to the at least one issuer institution confirming receipt of the funds to be deposited.

In further non-limiting embodiments or aspects, the at least one server computer may be programmed and/or configured to, in response to verifying receipt of new deposited funds in the predesignated account, generate, based at least partially on the balance of the predesignated account, at least one new transaction limit threshold for the at least one issuer institution. The at least one server computer may also be programmed and/or configured to receive new transaction data and determine, based at least partially on the new transaction data, the aggregate transaction volume. The at least one server computer may be further programmed and/or configured to compare the aggregate transaction volume to the at least one new transaction limit threshold. The at least one server computer may be further programmed and/or configured to generate a new communication to the at least one issuer institution including a request for the at least one issuer institution to deposit additional funds in the predesignated account. The at least one server computer may be further programmed and/or configured to verify a new receipt of funds into the predesignated account from the at least one issuer institution. The at least one server computer may be further programmed and/or configured to modify, based at least partially on the balance of the predesignated account, the at least one new transaction limit threshold for the predesignated account of the at least one issuer institution.

In further non-limiting embodiments or aspects, the at least one risk-mitigation action may include throttling incoming financial transactions from the at least one issuer institution by declining at least one incoming transaction based on at least one predetermined transaction parameter. The at least one predetermined transaction parameter of a given financial transaction may include at least one of the following: a transaction type of the financial transaction including a restricted type; a transaction amount of the financial transaction exceeding a restricted amount; a transaction time of the financial transaction being within a restricted time span since a prior financial transaction; or any combination thereof.

According to some non-limiting embodiments or aspects, provided is a computer program product for monitoring and managing at least one financial settlement account of at least one issuer institution. The computer program product includes at least one non-transitory computer-readable medium including program instructions that, when executed by at least one processor, cause the at least one processor to determine, based at least partially on historic transaction data, a minimum deposit requirement of a predesignated account associated with the at least one issuer institution. The instructions also cause the at least one processor to generate, based at least partially on a balance of the predesignated account, at least one transaction limit threshold for the at least one issuer institution. The instructions further cause the at least one processor to receive transaction data representative of a plurality of financial transactions between at least one merchant and at least one transaction device holder associated with the at least one issuer institution completed over a first time period. The transaction data includes at least transaction amounts of the plurality of financial transactions. The instructions further cause the at least one processor to determine, based at least partially on the transaction data, an aggregate transaction volume of the at least one issuer institution. The instructions further cause the at least one processor to compare the aggregate transaction volume to the at least one transaction limit threshold. The instructions further cause the at least one processor to, in response to the aggregate transaction volume equaling or exceeding the at least one transaction limit threshold, trigger at least one risk-mitigation action. The at least one risk-mitigation action includes at least one of the following: automatically transmitting a communication to the at least one issuer institution requesting additional funds to be deposited in the predesignated account; throttling incoming financial transactions from the at least one issuer institution by declining at least one incoming transaction based on at least one predetermined transaction parameter; declining all incoming financial transactions from the at least one issuer institution; or any combination thereof.

In further non-limiting embodiments or aspects, the at least one transaction limit threshold includes a first threshold amount and a second threshold amount greater than or equal to the first threshold amount. The triggering of the at least one risk-mitigation action may include, in response to the aggregate transaction volume meeting or exceeding the first threshold amount, automatically transmitting a communication to the at least one issuer institution requesting additional funds to be deposited in the predesignated account. The triggering of the at least one risk-mitigation action may also include, in response to the aggregate transaction volume meeting or exceeding the second threshold amount, throttling incoming financial transactions from the at least one issuer institution by declining at least one incoming transaction based on at least one predetermined transaction parameter. The at least one transaction limit threshold may also include a third threshold amount greater than or equal to the first threshold amount and the second threshold amount. The triggering of the at least one risk-mitigation action may further include, in response to the aggregate transaction volume meeting or exceeding the third threshold amount, declining all incoming financial transactions from the at least one issuer institution.

In further non-limiting embodiments or aspects, the instructions may cause the at least one processor to automatically generate a communication to the at least one issuer institution including a request for the at least one issuer institution to deposit funds in the predesignated account. The funds to be deposited may equal or exceed the minimum deposit requirement. The instructions may also cause the at least one processor to, in response to verifying that the balance of the predesignated account equals or exceeds the minimum deposit requirement, transmit a communication to the at least one issuer institution confirming receipt of the funds to be deposited.

In further non-limiting embodiments or aspects, the instructions may cause the at least one processor to, in response to verifying receipt of new deposited funds in the predesignated account, generate, based at least partially on the balance of the predesignated account, at least one new transaction limit threshold for the at least one issuer institution. The instructions may also cause the at least one processor to receive new transaction data and determine, based at least partially on the new transaction data, the aggregate transaction volume. The instructions may further cause the at least one processor to compare the aggregate transaction volume to the at least one new transaction limit threshold. The instructions may further cause the at least one processor to generate a new communication to the at least one issuer institution including a request for the at least one issuer institution to deposit additional funds in the predesignated account. The instructions may further cause the at least one processor to verify a new receipt of funds into the predesignated account from the at least one issuer institution. The instructions may further cause the at least one processor to modify, based at least partially on the balance of the predesignated account, the at least one new transaction limit threshold for the predesignated account of the at least one issuer institution.

In further non-limiting embodiments or aspects, the at least one risk-mitigation action may include throttling incoming financial transactions from the at least one issuer institution by declining at least one incoming transaction based on at least one predetermined transaction parameter. The at least one predetermined transaction parameter of a given financial transaction may include at least one of the following: a transaction type of the financial transaction including a restricted type; a transaction amount of the financial transaction exceeding a restricted amount; a transaction time of the financial transaction being within a restricted time span since a prior financial transaction; or any combination thereof.

Other non-limiting embodiments or aspects of the present invention will be set forth in the following numbered clauses:

Clause 1: A computer-implemented method for dynamically monitoring and managing at least one financial settlement account of at least one issuer institution, the method comprising: determining, with at least one processor and based at least partially on historic transaction data, a minimum deposit requirement of a predesignated account associated with the at least one issuer institution; generating, with at least one processor and based at least partially on a balance of the predesignated account, at least one transaction limit threshold for the at least one issuer institution; receiving, with at least one processor, transaction data representative of a plurality of financial transactions between at least one merchant and at least one transaction device holder associated with the at least one issuer institution completed over a first time period, the transaction data comprising at least transaction amounts of the plurality of financial transactions; determining, with at least one processor and based at least partially on the transaction data, an aggregate transaction volume of the at least one issuer institution; comparing, with at least one processor, the aggregate transaction volume to the at least one transaction limit threshold; and, in response to the aggregate transaction volume equaling or exceeding the at least one transaction limit threshold, triggering at least one risk-mitigation action with at least one processor, the at least one risk-mitigation action comprising at least one of the following: automatically transmitting a communication to the at least one issuer institution requesting additional funds to be deposited in the predesignated account; throttling incoming financial transactions from the at least one issuer institution by declining at least one incoming transaction based on at least one predetermined transaction parameter; declining all incoming financial transactions from the at least one issuer institution; or any combination thereof.

Clause 2: The computer-implemented method of clause 1, wherein the at least one transaction limit threshold comprises a first threshold amount and a second threshold amount greater than or equal to the first threshold amount, and wherein the triggering of the at least one risk-mitigation action comprises: in response to the aggregate transaction volume meeting or exceeding the first threshold amount, automatically transmitting, with at least one processor, a communication to the at least one issuer institution requesting additional funds to be deposited in the predesignated account; and, in response to the aggregate transaction volume meeting or exceeding the second threshold amount, throttling, with at least one processor, incoming financial transactions from the at least one issuer institution by declining at least one incoming transaction based on at least one predetermined transaction parameter.

Clause 3: The computer-implemented method of clause 1 or 2, wherein the at least one transaction limit threshold further comprises a third threshold amount greater than or equal to the first threshold amount and the second threshold amount, and wherein the triggering of the at least one risk-mitigation action comprises: in response to the aggregate transaction volume meeting or exceeding the third threshold amount, declining, with at least one processor, all incoming financial transactions from the at least one issuer institution.

Clause 4: The computer-implemented method of any of clauses 1-3, further comprising: automatically generating, with at least one processor, a communication to the at least one issuer institution comprising a request for the at least one issuer institution to deposit funds in the predesignated account, the funds to be deposited equal to or exceeding the minimum deposit requirement; and, in response to verifying that the balance of the predesignated account equals or exceeds the minimum deposit requirement, transmitting, with at least one processor, a communication to the at least one issuer institution confirming receipt of the funds to be deposited.

Clause 5: The computer-implemented method of any of clauses 1-4, further comprising: in response to verifying receipt of new deposited funds in the predesignated account, generating, with at least one processor and based at least partially on the balance of the predesignated account, at least one new transaction limit threshold for the at least one issuer institution.

Clause 6: The computer-implemented method of any of clauses 1-5, further comprising: receiving, with at least one processor, new transaction data; determining, with at least one processor and based at least partially on the new transaction data, the aggregate transaction volume; and comparing, with at least one processor, the aggregate transaction volume to the at least one new transaction limit threshold.

Clause 7: The computer-implemented method of any of clauses 1-6, further comprising: generating, with at least one processor, a new communication to the at least one issuer institution comprising a request for the at least one issuer institution to deposit additional funds in the predesignated account; verifying, with at least one processor, a new receipt of funds into the predesignated account from the at least one issuer institution; and modifying, with at least one processor and based at least partially on the balance of the predesignated account, the at least one new transaction limit threshold for the predesignated account of the at least one issuer institution.

Clause 8: The computer-implemented method of any of clauses 1-7, wherein the at least one risk-mitigation action comprises throttling incoming financial transactions from the at least one issuer institution by declining at least one incoming transaction based on at least one predetermined transaction parameter, the at least one predetermined transaction parameter of a given financial transaction comprising at least one of the following: a transaction type of the financial transaction comprising a restricted type; a transaction amount of the financial transaction exceeding a restricted amount; a transaction time of the financial transaction being within a restricted time span since a prior financial transaction; or any combination thereof.

Clause 9: A system for dynamically monitoring and managing at least one financial settlement account of at least one issuer institution, the system comprising at least one server computer including at least one processor, the at least one server computer programmed and/or configured to: determine, based at least partially on historic transaction data, a minimum deposit requirement of a predesignated account associated with the at least one issuer institution; generate, based at least partially on a balance of the predesignated account, at least one transaction limit threshold for the at least one issuer institution; receive transaction data representative of a plurality of financial transactions between at least one merchant and at least one transaction device holder associated with the at least one issuer institution completed over a first time period, the transaction data comprising at least transaction amounts of the plurality of financial transactions; determine, based at least partially on the transaction data, an aggregate transaction volume of the at least one issuer institution; compare the aggregate transaction volume to the at least one transaction limit threshold; and, in response to the aggregate transaction volume equaling or exceeding the at least one transaction limit threshold, trigger at least one risk-mitigation action comprising at least one of the following: automatically transmitting a communication to the at least one issuer institution requesting additional funds to be deposited in the predesignated account; throttling incoming financial transactions from the at least one issuer institution by declining at least one incoming transaction based on at least one predetermined transaction parameter; declining all incoming financial transactions from the at least one issuer institution; or any combination thereof.

Clause 10: The system of clause 9, wherein the at least one transaction limit threshold comprises a first threshold amount and a second threshold amount greater than or equal to the first threshold amount, and wherein the triggering of the at least one risk-mitigation action comprises: in response to the aggregate transaction volume meeting or exceeding the first threshold amount, automatically transmitting a communication to the at least one issuer institution requesting additional funds to be deposited in the predesignated account; and, in response to the aggregate transaction volume meeting or exceeding the second threshold amount, throttling incoming financial transactions from the at least one issuer institution by declining at least one incoming transaction based on at least one predetermined transaction parameter.

Clause 11: The system of clause 9 or 10, wherein the at least one transaction limit threshold further comprises a third threshold amount greater than or equal to the first threshold amount and the second threshold amount, and wherein the triggering of the at least one risk-mitigation action comprises: in response to the aggregate transaction volume meeting or exceeding the third threshold amount, declining all incoming financial transactions from the at least one issuer institution.

Clause 12: The system of any of clauses 9-11, wherein the at least one server computer is further programmed and/or configured to: automatically generate a communication to the at least one issuer institution comprising a request for the at least one issuer institution to deposit funds in the predesignated account, the funds to be deposited equal to or exceeding the minimum deposit requirement; and, in response to verifying that the balance of the predesignated account equals or exceeds the minimum deposit requirement, transmit a communication to the at least one issuer institution confirming receipt of the funds to be deposited.

Clause 13: The system of any of clauses 9-12, wherein the at least one server computer is further programmed and/or configured to: in response to verifying receipt of new deposited funds in the predesignated account, generate, based at least partially on the balance of the predesignated account, at least one new transaction limit threshold for the at least one issuer institution.

Clause 14: The system of any of clauses 9-13, wherein the at least one server computer is further programmed and/or configured to: receive new transaction data; determine, based at least partially on the new transaction data, the aggregate transaction volume; and compare the aggregate transaction volume to the at least one new transaction limit threshold.

Clause 15: The system of any of clauses 9-14, wherein the at least one server computer is further programmed and/or configured to: generate a new communication to the at least one issuer institution comprising a request for the at least one issuer institution to deposit additional funds in the predesignated account; verify a new receipt of funds into the predesignated account from the at least one issuer institution; and modify, based at least partially on the balance of the predesignated account, the at least one new transaction limit threshold for the predesignated account of the at least one issuer institution.

Clause 16: The system of any of clauses 9-15, wherein the at least one risk-mitigation action comprises throttling incoming financial transactions from the at least one issuer institution by declining at least one incoming transaction based on at least one predetermined transaction parameter, the at least one predetermined transaction parameter of a given financial transaction comprising at least one of the following: a transaction type of the financial transaction comprising a restricted type; a transaction amount of the financial transaction exceeding a restricted amount; a transaction time of the financial transaction being within a restricted time span since a prior financial transaction; or any combination thereof.

Clause 17: A computer program product for monitoring and managing at least one financial settlement account of at least one issuer institution, the computer program product comprising at least one non-transitory computer-readable medium including program instructions that, when executed by at least one processor, cause the at least one processor to: determine, based at least partially on historic transaction data, a minimum deposit requirement of a predesignated account associated with the at least one issuer institution; generate, based at least partially on a balance of the predesignated account, at least one transaction limit threshold for the at least one issuer institution; receive transaction data representative of a plurality of financial transactions between at least one merchant and at least one transaction device holder associated with the at least one issuer institution completed over a first time period, the transaction data comprising at least transaction amounts of the plurality of financial transactions; determine, based at least partially on the transaction data, an aggregate transaction volume of the at least one issuer institution; compare the aggregate transaction volume to the at least one transaction limit threshold; and, in response to the aggregate transaction volume equaling or exceeding the at least one transaction limit threshold, trigger at least one risk-mitigation action comprising at least one of the following: automatically transmitting a communication to the at least one issuer institution requesting additional funds to be deposited in the predesignated account; throttling incoming financial transactions from the at least one issuer institution by declining at least one incoming transaction based on at least one predetermined transaction parameter; declining all incoming financial transactions from the at least one issuer institution; or any combination thereof.

Clause 18: The computer program product of clause 17, wherein the at least one transaction limit threshold comprises a first threshold amount and a second threshold amount greater than or equal to the first threshold amount, and wherein the triggering of the at least one risk-mitigation action comprises: in response to the aggregate transaction volume meeting or exceeding the first threshold amount, automatically transmitting a communication to the at least one issuer institution requesting additional funds to be deposited in the predesignated account; and, in response to the aggregate transaction volume meeting or exceeding the second threshold amount, throttling incoming financial transactions from the at least one issuer institution by declining at least one incoming transaction based on at least one predetermined transaction parameter.

Clause 19: The computer program product of clause 17 or 18, wherein the at least one transaction limit threshold further comprises a third threshold amount greater than or equal to the first threshold amount and the second threshold amount, and wherein the triggering of the at least one risk-mitigation action comprises: in response to the aggregate transaction volume meeting or exceeding the third threshold amount, declining all incoming financial transactions from the at least one issuer institution.

Clause 20: The computer program product of any of clauses 17-19, wherein the instructions further cause the at least one processor to: automatically generate a communication to the at least one issuer institution comprising a request for the at least one issuer institution to deposit funds in the predesignated account, the funds to be deposited equal to or exceeding the minimum deposit requirement; and, in response to verifying that the balance of the predesignated account equals or exceeds the minimum deposit requirement, transmit a communication to the at least one issuer institution confirming receipt of the funds to be deposited.

Clause 21: The computer program product of any of clauses 17-20, wherein the instructions further cause the at least one processor to: in response to verifying receipt of new deposited funds in the predesignated account, generate, based at least partially on the balance of the predesignated account, at least one new transaction limit threshold for the at least one issuer institution.

Clause 22: The computer program product of any of clauses 17-21, wherein the instructions further cause the at least one processor to: receive new transaction data; determine, based at least partially on the new transaction data, the aggregate transaction volume; and compare the aggregate transaction volume to the at least one new transaction limit threshold.

Clause 23: The computer program product of any of clauses 17-22, wherein the instructions further cause the at least one processor to: generate a new communication to the at least one issuer institution comprising a request for the at least one issuer institution to deposit additional funds in the predesignated account; verify a new receipt of funds into the predesignated account from the at least one issuer institution; and modify, based at least partially on the balance of the predesignated account, the at least one new transaction limit threshold for the predesignated account of the at least one issuer institution.

Clause 24: The computer program product of any of clauses 17-23, wherein the at least one risk-mitigation action comprises throttling incoming financial transactions from the at least one issuer institution by declining at least one incoming transaction based on at least one predetermined transaction parameter, the at least one predetermined transaction parameter of a given financial transaction comprising at least one of the following: a transaction type of the financial transaction comprising a restricted type; a transaction amount of the financial transaction exceeding a restricted amount; a transaction time of the financial transaction being within a restricted time span since a prior financial transaction; or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figure, in which:

FIG. 1 is a schematic diagram of an existing system and method for dynamically monitoring and managing at least one financial settlement account of at least one issuer institution;

FIG. 2 is a schematic diagram of one embodiment or aspect of a system and method for dynamically monitoring and managing at least one financial settlement account of at least one issuer institution;

FIG. 3 is a schematic diagram of one embodiment or aspect of a system and method for dynamically monitoring and managing at least one financial settlement account of at least one issuer institution;

FIG. 4 is a flow diagram of one embodiment or aspect of a system and method for dynamically monitoring and managing at least one financial settlement account of at least one issuer institution; and

FIG. 5 is a flow diagram of one embodiment or aspect of a system and method for dynamically monitoring and managing at least one financial settlement account of at least one issuer institution;

### DETAILED DESCRIPTION OF THE INVENTION

For purposes of the description hereinafter, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and process illustrated in the attached drawings, and described in the following specification, are simply exemplary embodiments of the invention. Hence, specific dimensions and other physical characteristics related to the embodiments disclosed herein are not to be considered as limiting. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the terms “transaction device”, “portable financial device”, and/or “financial device” may refer to a portable payment card (e.g., a credit or debit card), a gift card, a smartcard, smart media, a payroll card, a healthcare card, a wrist band, a machine-readable medium containing account information (e.g., one or more account identifiers, user identifiers, transaction histories, balances, credit limits, issuer institution identifiers, and/or the like), a keychain device or fob, an RFID transponder, a retailer discount or loyalty card, a mobile device executing an electronic wallet application, a personal digital assistant, a security card, an access card, a wireless terminal, and/or a transponder, as examples. The financial device may include a volatile or a non-volatile memory to store information, such as an account identifier or a name of the account holder. The financial device may store account credentials locally on the device, in digital or non-digital representation, or may facilitate accessing account credentials stored in a medium that is accessible by the financial device in a connected network.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., POS devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In non-limiting embodiments or aspects of the present invention, the target users of the present invention may be issuer institutions that are a greater credit risk and cannot be trusted to complete transactions on credit without some amount of upfront payment. Therefore, non-limiting embodiments or aspects of the present invention implement predesignated accounts (e.g., prefund accounts), the balance of which may be monitored by one or more processors. Financial settlement risk personnel may set initial thresholds for issuer institution users and initial balance requirements for the predesignated accounts. The system may aggregate credit transaction volume (over a time period, e.g., a day) for a given issuer institution and automatically monitor the volume in comparison with tiered credit limit thresholds. When the tiered credit limit thresholds are exceeded, the system may trigger automatic communications to users, throttle user accounts, or decline user transactions. These tiers may be structured at progressively higher threshold amounts.

In further non-limiting embodiments or aspects, the tiered thresholds may be flexible and adjustable, such as when implemented with intelligent (e.g., machine-learning) algorithms. As tiered credit limit thresholds are approached or reached, the system sends communications to issuers, soliciting the issuers to make deposits into the predesignated account (e.g., prefund account). If deposits are received, the thresholds may be automatically raised. If deposits are not received, the thresholds may be maintained or even lowered, until an issuer is completely throttled or declined. With implementation of machine-learning algorithms, thresholds may be dynamically set based on any number of variables from historic data, including: seasonality (e.g., holidays), trends, available collateral, similarly-situated issuers, deposit history, transaction density (i.e., ratio of transaction amount to transaction count), and/or the like. This will help account for variance and changes in credit limit levels.

Non-limiting embodiments or aspects of the present invention are directed to dynamically monitoring and managing at least one financial settlement account (e.g., financial settlement account) of at least one issuer institution. Embodiments or aspects of the present invention provide a computer system and network, including at least one server computer, to monitor financial transactions (e.g., credit transactions, debit transactions, etc.), dynamically aggregate financial transaction volume for multiple issuer institutions on a real-time basis, and dynamically adjust transaction thresholds in response to automatic interactions between a transaction service provider and issuer institutions. Embodiments or aspects of the present invention provide the tools and systems for drastically improving over prior manual risk-mitigation processes by transaction settlement risk personnel, as well as for computing thresholds, requesting deposits, monitoring predesignated accounts (e.g., prefund accounts), and taking risk-mitigation actions where previously personnel could not equivalently function.

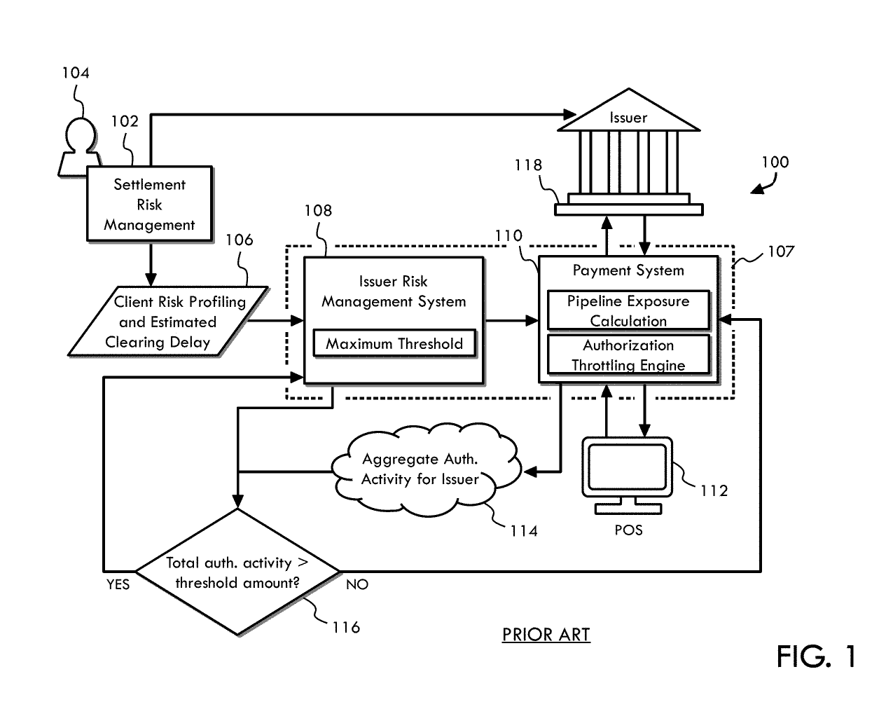

With specific reference to FIG. 1, depicted is an existing financial settlement risk management system. This existing system 100 includes a financial settlement risk management system 102 having financial settlement risk personnel 104 that manually enter transaction thresholds for every issuer institution 118 set up in the issuer risk management system 108. Financial transaction risk rules and parameters for each issuer institution 118 (e.g., threshold amounts, threshold trigger actions, credit clearing days, etc.) are defined by financial settlement risk personnel 104 in issuer risk profiles 106 on a server through the issuer risk management system 108 of a transaction service provider 107. Transaction requests received from merchant point of sale systems 112 for a given issuer institution 118 are monitored by the transaction service provider 107 payment system 110 that has an interface with the issuer risk management system 108. A standard authorization process for each transaction is followed, during which an aggregate of authorized activity 114 is calculated over a period of time defined by the parameters on the issuer risk management system 108. This period of time, for example, is the number of clearing days for a financial settlement account. The aggregate authorized activity 114 for the issuer institution 118 is evaluated in a comparison 116 with the various manually set thresholds set on the issuer risk management system 108. If the aggregate authorized activity 114 is lower than a threshold value during the comparison 116, then transactions for the issuer institution 118 are processed normally through the payment system 110. If the aggregate authorized activity 114 is greater than a threshold value, then a risk management rule gets activated and the issuer risk management system 108 informs the payment system 110 to start throttling/declining transactions belonging to the issuer institution 118. The financial settlement risk management system 102 is then notified of the declines to transactions, and then financial settlement risk personnel 104 act to contact the issuer institution 118 and ask them to settle their outstanding position. Based on the issuer institution's 118 response to the financial settlement risk personnel 104, the thresholds in the issuer risk management system may be reset and processed normally.

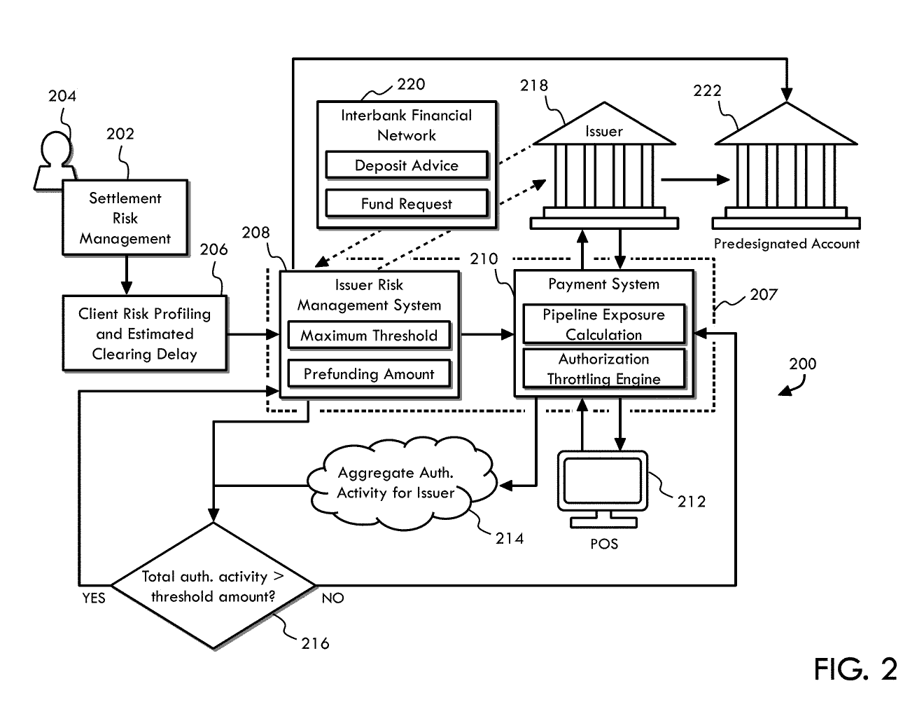

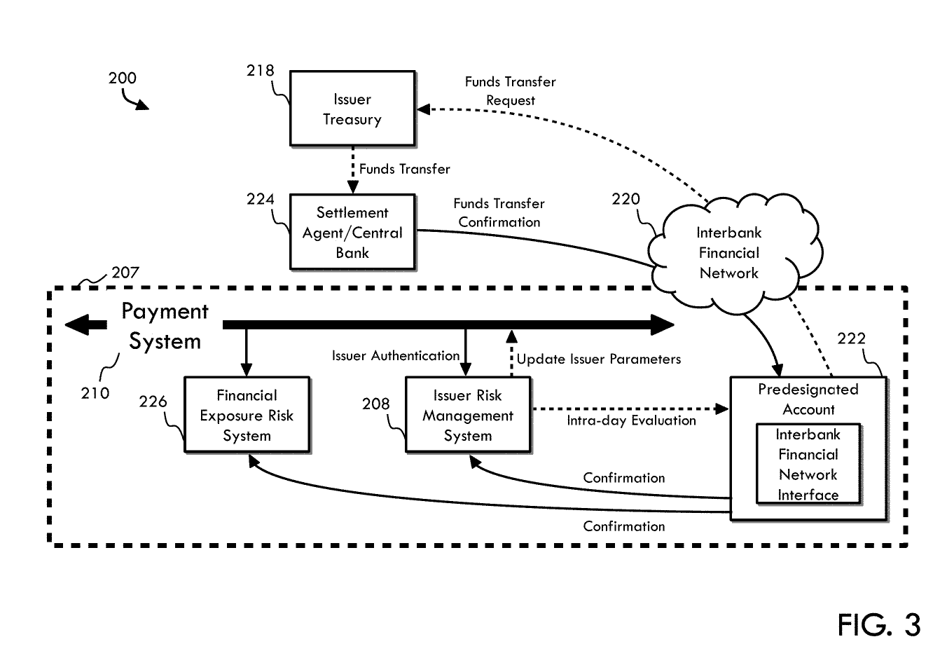

With specific reference to FIGS. 2 and 3, and in non-limiting embodiments or aspects of the invention, provided is a system and method 200 for dynamically monitoring and managing at least one financial settlement account of at least one issuer institution. Financial settlement risk personnel 204 play a comparatively smaller role in the settlement risk management system 202, namely entering the balance of a predesignated account 222 for each issuer institution 218, and, optionally, entering initial threshold rules and parameters with trigger actions. Transaction requests received from merchant point of sale systems 212 are initially authorized normally while an aggregate authorized activity 214 for the issuer institution 218 is calculated. The aggregate authorized activity 214 is evaluated in a comparison 216 with the prefunding amount deposited by the issuer institution 218. If the aggregate authorized activity 214 is lower than the threshold value in the comparison 216, the transactions for the issuer institution are processed normally in the payment system 210. If the aggregate authorized activity 214 is greater than the threshold value in the comparison 216, the authorization throttling engine of the issuer risk management system 208 activates risk mitigating actions and alerts and informs the payment system 210 to start throttling/declining transactions for the issuer institution 218. The issuer risk management system 208 then sends an automated funds request message to the issuer institution 218 via an interbank financial network 220 notification. If funds are not received within a particular time period, the issuer risk management system may lower the threshold for the issuer institution's 218 authorized activity. However, once a notification of deposited funds is received via the interbank financial network 220, the issuer risk management system 208 may increase the threshold limit for the issuer institution 218, based at least partially on the amount received from the issuer institution 218. The issuer risk management system 208 continues to track the balance of funds available in the predesignated account. The issuer risk management system 208 and the payment system are associated with the transaction service provider 207, and the aggregation of authorized activity 214 and its comparison 216 to the thresholds may be associated with those transaction service provider 207 components. The interbank financial network may also be associated with the transaction service provider 207. Other configurations are possible.

With further reference to FIGS. 2 and 3, and in further non-limiting embodiments or aspects, the transaction service provider 207 pre-calculates the initial prefunding amount that the issuer institution 218 needs to deposit into a transaction service provider 207 predesignated account 222 for financial settlement. The transaction service provider 207 sends a prefunding request via the interbank financial network 220 to the issuer institution 218. As soon as the issuer institution deposits the initial prefunding amount into the predesignated account 222, such as by a settlement agent/central bank 224, the transaction service provider 207 receives an interbank financial network 220 message confirming the deposit. The transaction service provider monitors the authorization transaction activity received from merchant point of sale systems 212 throughout the day in real time. If any time during the day the aggregate authorized activity 214 exceeds a predefined threshold, the transaction service provider's 207 settlement option rules engine, associated with the issuer risk management system 208, will generate a new request for an additional deposit by the issuer institution 218. If the transaction service provider 207 does not receive a deposit confirmation, then the transaction service provider's 207 settlement options rules engine will take one or more risk mitigation actions, such as throttling transactions or declining transactions, or lower the threshold. Artificial intelligence tools, such as neural networks, may be used by the issuer risk management system 208 to train the settlement option rules engine to preset/predict the issuer institution's 218 daily activity based on historical volumes, as well as to dynamically set thresholds and actions. In the depicted system, there is no need for manual intervention, as all notifications, threshold levels, and risk mitigation actions are handled and determined automatically. The system also may include a financial exposure risk system 226, which receives the data feed from daily authorizations and clearing and settlement systems, and which is used to track the settlement positions for all of issuer institutions interacting with the transaction service provider.

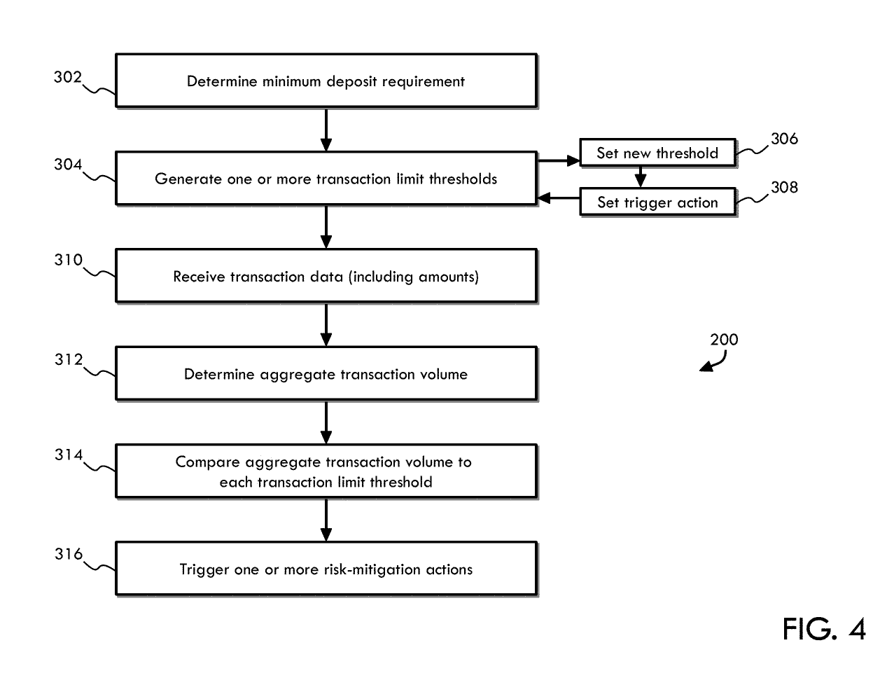

With specific reference to FIG. 4, and in non-limiting embodiments or aspects, provided is a computer-implemented method 200 for dynamically monitoring and managing at least one financial settlement account of at least one issuer institution, to be executed by at least one processor. At step 302, and based at least partially on historic transaction data (e.g., transaction amount, transaction count, transaction time, credit transaction repayment history, etc.), a minimum deposit requirement is determined for a predesignated account (e.g., prefund account) associated with an issuer institution. The minimum deposit requirement is an amount that must be deposited in the predesignated account for the issuer institution to have its financial transactions authorized. At step 304, based at least partially on the balance of the predesignated account, one or more transaction limit thresholds are generated for the issuer institution. This may include setting a dollar amount for each new threshold, at step 306, where each threshold is greater than or equal to a previous threshold. Each threshold may also be given, at step 308, a specific risk-mitigating action to trigger when the threshold is equaled or exceeded. For example, a first threshold may be set at a first amount (e.g., $10,000) where, if the aggregate activity by the issuer institution equals or exceeds the first threshold, an automatic message is sent to the issuer institution to request additional predesignated account funds. Further, a second threshold may be set at a second amount (e.g., $15,000) where, if the aggregate activity by the issuer institution equals or exceeds the second threshold, transactions associated with the issuer institution are throttled (i.e., selectively declined). Throttling may be conducted according to one or more parameters, such as: a transaction type of the financial transaction comprising a restricted type (e.g., online, face-to-face, clothing, luxury, gasoline, etc.); a transaction amount of the financial transaction exceeding a restricted amount; a transaction time of the financial transaction being within a restricted time span since a prior financial transaction; and/or the like. Further, a third threshold may be set at a third amount (e.g., $20,000) where, if the aggregate activity by the issuer institution equals or exceeds the third threshold, all transactions associated with the issuer institution are declined. Other configurations are possible.

With further reference to FIG. 4, and in further non-limiting embodiments or aspects, at step 310, the method 200 includes receiving transaction data that is representative of a one or more financial transactions between at least one merchant and at least one transaction device holder who is associated with the at least one issuer institution. The transactions of the transaction data correspond to those completed in a first time period (e.g., the current or prior day). The transaction data includes at least transaction amounts of the financial transactions, but may also include transaction time, type, description, merchant, and/or the like. At step 312, the method 200 includes determining, based at least partially on the transaction data, an aggregate transaction volume of the at least one issuer institution. For example, the transaction amount for each transaction occurring since the day began may be summed to produce the aggregate transaction volume. Alternatively, not all transactions may contribute to the aggregate transaction volume and may be automatically filtered out from the summation by a parameter such as transaction type, time, merchant, description, and/or the like. At step 314, the method 200 includes comparing the aggregate transaction volume to the at least one transaction limit threshold. For example, the processor may compare the aggregate transaction volume to the first threshold, the second threshold, and third threshold, and for each threshold that is equaled or exceeded, the processor may execute the associated risk-mitigating action. It will be appreciated that this process may be followed for any number of thresholds. At step 316, if one or more thresholds are equaled or exceeded, the method 200 includes triggering one or more risk-mitigation actions, such as automatically transmitting a communication to the issuer institution requesting additional funds to be deposited in the predesignated account; throttling incoming financial transactions from the issuer institution by declining at least one incoming transaction based on at least one predetermined transaction parameter; declining all incoming financial transactions from the issuer institution; and/or the like. Other configurations are possible.

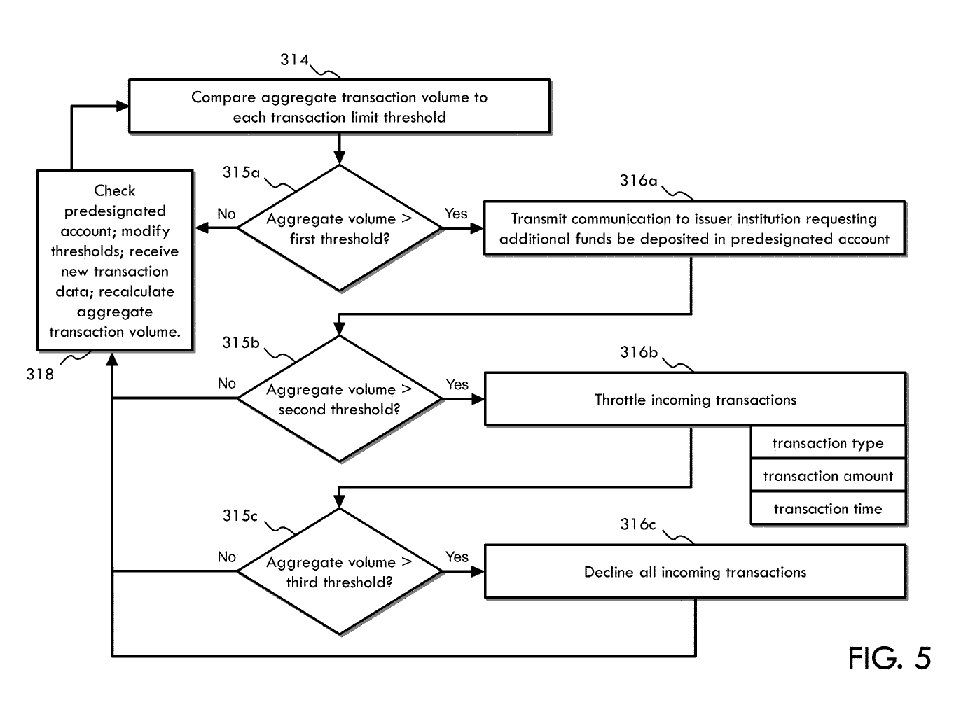

With specific reference to FIG. 5, and in non-limiting embodiments or aspects, provided is a computer-implemented method 200 for dynamically monitoring and managing at least one financial settlement account of at least one issuer institution, to be executed by at least one processor. Depicted is one example arrangement of three thresholds, each successively higher than the preceding threshold, with associated risk-mitigation trigger actions. At step 314, the aggregate transaction volume is compared to each transaction limit threshold, which is reflected in comparison steps 315a-315c and associated risk-mitigation actions 316a-316c. For example, the processor may first compare the aggregate volume to the first threshold. If the aggregate volume exceeds (and/or equals) the first threshold at step 315a, the processor may automatically transmit a communication to the issuer institution requesting additional funds to be deposited in the predesignated account, at step 316a. The evaluation process may then continue to step 315b. If the aggregate volume exceeds (and/or equals) the second threshold at step 315b, the processor may automatically throttle incoming financial transactions from the at least one issuer institution by declining at least one incoming transaction based on at least one predetermined transaction parameter. The evaluation process may then continue to step 315c. If the aggregate volume exceeds (and/or equals) the third threshold at step 315c, the processor may automatically decline all incoming financial transactions from the at least one issuer institution.

With further reference to FIG. 5, and in further non-limiting embodiments or aspects, after the evaluation steps 315a-315c and any triggered risk-mitigating actions 316a-316c are executed, the method 200 includes a series of cyclical actions 318: checking the balance of the predesignated account or checking for any predesignated account deposit receipts; modifying the preset thresholds, if the predesignated account balance has been increased or predesignated account deposits have been received; receiving new transaction data from a second time period, which may include the first time period; and, recalculating the aggregate transaction volume to account for any newly received transactions. The method 200 may then proceed to re-execute the threshold comparison steps 315a-316c and start or stop any associated risk-mitigation actions 316a-316c. For example, a threshold that was previously crossed may no longer be crossed, and, therefore, the associated risk-mitigation action may be ceased. Alternatively, a threshold that was previously uncrossed may suddenly be crossed, and, therefore, one or more risk-mitigation actions must be taken. Still more, a threshold may continue to be crossed and the associated risk-mitigation action must be continued. It will be appreciated that many configurations are possible.

Although the invention has been described in detail for the purpose of illustration based on what is currently considered to be the most practical and non-limiting embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for dynamically monitoring and managing at least one financial settlement account of at least one issuer institution, the method comprising:
determining, with at least one processor and based at least partially on historic transaction data, a minimum deposit requirement of a predesignated account associated with the at least one issuer institution;
generating, with at least one processor and based at least partially on a balance of the predesignated account, at least one transaction limit threshold for the at least one issuer institution;
receiving, with at least one processor, transaction data representative of a plurality of financial transactions between at least one merchant and at least one transaction device holder associated with the at least one issuer institution completed over a first time period, the transaction data comprising at least transaction amounts of the plurality of financial transactions;
determining, with at least one processor and based at least partially on the transaction data, an aggregate transaction volume of the at least one issuer institution;
comparing, with at least one processor, the aggregate transaction volume to the at least one transaction limit threshold; and
in response to the aggregate transaction volume equaling or exceeding the at least one transaction limit threshold, triggering at least one risk-mitigation action with at least one processor, the at least one risk-mitigation action comprising at least one of the following: automatically transmitting a communication to the at least one issuer institution requesting additional funds to be deposited in the predesignated account; automatically transmitting a communication to the at least one issuer institution warning of other impending or recently implemented risk-mitigation actions; throttling incoming financial transactions from the at least one issuer institution by declining at least one incoming transaction based on at least one predetermined transaction parameter; declining all incoming financial transactions from the at least one issuer institution; or any combination thereof.

2. The computer-implemented method of claim 1, wherein the at least one transaction limit threshold comprises a first threshold amount and a second threshold amount greater than or equal to the first threshold amount, and wherein the triggering of the at least one risk-mitigation action comprises:
in response to the aggregate transaction volume meeting or exceeding the first threshold amount, automatically transmitting, with at least one processor, a communication to the at least one issuer institution requesting additional funds to be deposited in the predesignated account; and
in response to the aggregate transaction volume meeting or exceeding the second threshold amount, throttling, with at least one processor, incoming financial transactions from the at least one issuer institution by declining at least one incoming transaction based on at least one predetermined transaction parameter.

3. The computer-implemented method of claim 2, wherein the at least one transaction limit threshold further comprises a third threshold amount greater than or equal to the first threshold amount and the second threshold amount, and wherein the triggering of the at least one risk-mitigation action comprises:
in response to the aggregate transaction volume meeting or exceeding the third threshold amount, declining, with at least one processor, all incoming financial transactions from the at least one issuer institution.

4. The computer-implemented method of claim 1, further comprising:
automatically generating, with at least one processor, a communication to the at least one issuer institution comprising a request for the at least one issuer institution to deposit funds in the predesignated account, the funds to be deposited equal to or exceeding the minimum deposit requirement; and
in response to verifying that the balance of the predesignated account equals or exceeds the minimum deposit requirement, transmitting, with at least one processor, a communication to the at least one issuer institution confirming receipt of the funds to be deposited.

5. The computer-implemented method of claim 1, further comprising:
in response to verifying receipt of new deposited funds in the predesignated account, generating, with at least one processor and based at least partially on the balance of the predesignated account, at least one new transaction limit threshold for the at least one issuer institution.

6. The computer-implemented method of claim 5, further comprising:
receiving, with at least one processor, new transaction data;
determining, with at least one processor and based at least partially on the new transaction data, the aggregate transaction volume; and
comparing, with at least one processor, the aggregate transaction volume to the at least one new transaction limit threshold.

7. The computer-implemented method of claim 6, further comprising:
generating, with at least one processor, a new communication to the at least one issuer institution comprising a request for the at least one issuer institution to deposit additional funds in the predesignated account;
verifying, with at least one processor, a new receipt of funds into the predesignated account from the at least one issuer institution; and
modifying, with at least one processor and based at least partially on the balance of the predesignated account, the at least one new transaction limit threshold for the predesignated account of the at least one issuer institution.

8. The computer-implemented method of claim 1, wherein the at least one risk-mitigation action comprises throttling incoming financial transactions from the at least one issuer institution by declining at least one incoming transaction based on at least one predetermined transaction parameter, the at least one predetermined transaction parameter of a given financial transaction comprising at least one of the following: a transaction type of the financial transaction comprising a restricted type; a transaction amount of the financial transaction exceeding a restricted amount; a transaction time of the financial transaction being within a restricted time span since a prior financial transaction; or any combination thereof.

9. A system for dynamically monitoring and managing at least one financial settlement account of at least one issuer institution, the system comprising at least one server computer including at least one processor, the at least one server computer programmed and/or configured to:
determine, based at least partially on historic transaction data, a minimum deposit requirement of a predesignated account associated with the at least one issuer institution;
generate, based at least partially on a balance of the predesignated account, at least one transaction limit threshold for the at least one issuer institution;
receive transaction data representative of a plurality of financial transactions between at least one merchant and at least one transaction device holder associated with the at least one issuer institution completed over a first time period, the transaction data comprising at least transaction amounts of the plurality of financial transactions;
determine, based at least partially on the transaction data, an aggregate transaction volume of the at least one issuer institution;
compare the aggregate transaction volume to the at least one transaction limit threshold; and
in response to the aggregate transaction volume equaling or exceeding the at least one transaction limit threshold, trigger at least one risk-mitigation action comprising at least one of the following: automatically transmitting a communication to the at least one issuer institution requesting additional funds to be deposited in the predesignated account; automatically transmitting a communication to the at least one issuer institution warning of other impending or recently implemented risk-mitigation actions; throttling incoming financial transactions from the at least one issuer institution by declining at least one incoming transaction based on at least one predetermined transaction parameter; declining all incoming financial transactions from the at least one issuer institution; or any combination thereof.

10. The system of claim 9, wherein the at least one transaction limit threshold comprises a first threshold amount and a second threshold amount greater than or equal to the first threshold amount, and wherein the triggering of the at least one risk-mitigation action comprises:
in response to the aggregate transaction volume meeting or exceeding the first threshold amount, automatically transmitting a communication to the at least one issuer institution requesting additional funds to be deposited in the predesignated account; and
in response to the aggregate transaction volume meeting or exceeding the second threshold amount, throttling incoming financial transactions from the at least one issuer institution by declining at least one incoming transaction based on at least one predetermined transaction parameter.

11. The system of claim 10, wherein the at least one transaction limit threshold further comprises a third threshold amount greater than or equal to the first threshold amount and the second threshold amount, and wherein the triggering of the at least one risk-mitigation action comprises:
in response to the aggregate transaction volume meeting or exceeding the third threshold amount, declining all incoming financial transactions from the at least one issuer institution.

12. The system of claim 9, wherein the at least one server computer is further programmed and/or configured to:
automatically generate a communication to the at least one issuer institution comprising a request for the at least one issuer institution to deposit funds in the predesignated account, the funds to be deposited equal to or exceeding the minimum deposit requirement; and
in response to verifying that the balance of the predesignated account equals or exceeds the minimum deposit requirement, transmit a communication to the at least one issuer institution confirming receipt of the funds to be deposited.

13. The system of claim 9, wherein the at least one server computer is further programmed and/or configured to:
in response to verifying receipt of new deposited funds in the predesignated account, generate, based at least partially on the balance of the predesignated account, at least one new transaction limit threshold for the at least one issuer institution.

14. The system of claim 13, wherein the at least one server computer is further programmed and/or configured to:
receive new transaction data;
determine, based at least partially on the new transaction data, the aggregate transaction volume; and
compare the aggregate transaction volume to the at least one new transaction limit threshold.

15. The system of claim 14, wherein the at least one server computer is further programmed and/or configured to:
generate a new communication to the at least one issuer institution comprising a request for the at least one issuer institution to deposit additional funds in the predesignated account;
verify a new receipt of funds into the predesignated account from the at least one issuer institution; and
modify, based at least partially on the balance of the predesignated account, the at least one new transaction limit threshold for the predesignated account of the at least one issuer institution.

16. The system of claim 9, wherein the at least one risk-mitigation action comprises throttling incoming financial transactions from the at least one issuer institution by declining at least one incoming transaction based on at least one predetermined transaction parameter, the at least one predetermined transaction parameter of a given financial transaction comprising at least one of the following: a transaction type of the financial transaction comprising a restricted type; a transaction amount of the financial transaction exceeding a restricted amount; a transaction time of the financial transaction being within a restricted time span since a prior financial transaction; or any combination thereof.

17. A computer program product for monitoring and managing at least one financial settlement account of at least one issuer institution, the computer program product comprising at least one non-transitory computer-readable medium including program instructions that, when executed by at least one processor, cause the at least one processor to:
determine, based at least partially on historic transaction data, a minimum deposit requirement of a predesignated account associated with the at least one issuer institution;
generate, based at least partially on a balance of the predesignated account, at least one transaction limit threshold for the at least one issuer institution;
receive transaction data representative of a plurality of financial transactions between at least one merchant and at least one transaction device holder associated with the at least one issuer institution completed over a first time period, the transaction data comprising at least transaction amounts of the plurality of financial transactions;
determine, based at least partially on the transaction data, an aggregate transaction volume of the at least one issuer institution;
compare the aggregate transaction volume to the at least one transaction limit threshold; and
in response to the aggregate transaction volume equaling or exceeding the at least one transaction limit threshold, trigger at least one risk-mitigation action comprising at least one of the following: automatically transmitting a communication to the at least one issuer institution requesting additional funds to be deposited in the predesignated account; automatically transmitting a communication to the at least one issuer institution warning of other impending or recently implemented risk-mitigation actions; throttling incoming financial transactions from the at least one issuer institution by declining at least one incoming transaction based on at least one predetermined transaction parameter; declining all incoming financial transactions from the at least one issuer institution; or any combination thereof.

18. The computer program product of claim 17, wherein the at least one transaction limit threshold comprises a first threshold amount and a second threshold amount greater than or equal to the first threshold amount, and wherein the triggering of the at least one risk-mitigation action comprises:
in response to the aggregate transaction volume meeting or exceeding the first threshold amount, automatically transmitting a communication to the at least one issuer institution requesting additional funds to be deposited in the predesignated account; and
in response to the aggregate transaction volume meeting or exceeding the second threshold amount, throttling incoming financial transactions from the at least one issuer institution by declining at least one incoming transaction based on at least one predetermined transaction parameter.

19. The computer program product of claim 18, wherein the at least one transaction limit threshold further comprises a third threshold amount greater than or equal to the first threshold amount and the second threshold amount, and wherein the triggering of the at least one risk-mitigation action comprises:
in response to the aggregate transaction volume meeting or exceeding the third threshold amount, declining all incoming financial transactions from the at least one issuer institution.

20. The computer program product of claim 17, wherein the instructions further cause the at least one processor to:
automatically generate a communication to the at least one issuer institution comprising a request for the at least one issuer institution to deposit funds in the predesignated account, the funds to be deposited equal to or exceeding the minimum deposit requirement; and
in response to verifying that the balance of the predesignated account equals or exceeds the minimum deposit requirement, transmit a communication to the at least one issuer institution confirming receipt of the funds to be deposited.

21. The computer program product of claim 17, wherein the instructions further cause the at least one processor to:
in response to verifying receipt of new deposited funds in the predesignated account, generate, based at least partially on the balance of the predesignated account, at least one new transaction limit threshold for the at least one issuer institution.

22. The computer program product of claim 21, wherein the instructions further cause the at least one processor to:
receive new transaction data;
determine, based at least partially on the new transaction data, the aggregate transaction volume; and
compare the aggregate transaction volume to the at least one new transaction limit threshold.

23. The computer program product of claim 22, wherein the instructions further cause the at least one processor to:
generate a new communication to the at least one issuer institution comprising a request for the at least one issuer institution to deposit additional funds in the predesignated account;
verify a new receipt of funds into the predesignated account from the at least one issuer institution; and
modify, based at least partially on the balance of the predesignated account, the at least one new transaction limit threshold for the predesignated account of the at least one issuer institution.

24. The computer program product of claim 17, wherein the at least one risk-mitigation action comprises throttling incoming financial transactions from the at least one issuer institution by declining at least one incoming transaction based on at least one predetermined transaction parameter, the at least one predetermined transaction parameter of a given financial transaction comprising at least one of the following: a transaction type of the financial transaction comprising a restricted type; a transaction amount of the financial transaction exceeding a restricted amount; a transaction time of the financial transaction being within a restricted time span since a prior financial transaction; or any combination thereof.
